(19) United States
(12) Patent Application Publication
(10) Pub. No.: US 2017/0371496 A1
(43) Pub. Date: Dec. 28, 2017

(54) RAPIDLY SKIMMABLE PRESENTATIONS OF WEB MEETING RECORDINGS

(71) Applicant: FUJI XEROX CO., LTD., Tokyo (JP)

(72) Inventors: Laurent Denoue, Verona (IT); Andreas Girgensohn, Palo Alto, CA (US); Scott Carter, Mountain View, CA (US); Jennifer Marlow, Palo Alto, CA (US); Matthew L. Cooper, San Francisco, CA (US)

(21) Appl. No.: 15/189,635

(22) Filed: Jun. 22, 2016

(51) Int. Cl. G06F 3/0481; G06F 3/16; H04L 29/06; G10L 15/08; G06T 11/60

(52) U.S. Cl. CPC G06F 3/0481; H04L 65/403; G10L 15/08; G06F 3/165; G06T 11/60; G10L 2015/088

(57) ABSTRACT

Example implementations described herein are directed to systems and methods for representing meeting content. Such implementations may involve processing an online presentation for one or more media segments, extracting information from the one or more media segments indicative of one or more relationships between one or more participants of the online presentation and generating an interface for the online presentation, the interface indicative of the one or more relationships between the one or more participants of the online presentation. Through such example implementations, online presentations can be indexed and an interface can be generated for the online presentation that allows for content of the presentation to be searchable.

### BACKGROUND

### Field

The present disclosure is directed to conferencing systems, and more specifically, to generation of rapidly skimmable presentations from recordings of web meetings.

### Related Art

In related art implementations, there are web-based video conferencing tools that allow users to meet online and share their webcam, screens, and exchange pictures and text messages. Related art implementations allow users to record and index such meetings based on who was present, what their webcam or screen-share looked like with judiciously selected key frames, when they spoke (using voice activity detection), and what their actions were over shared content.

In related art implementations, web meetings were archived using a flat video file, either as one per participant or as a combined, tiled view of all of the streams of the participants. However, such a linear video may be burdensome for browsing meetings, such as to understand who spoke when, or to browse the nature of turn taking in the meeting (e.g., was there one person talking for a long time, what was the speaker talking about, what were the others pointing at, etc.).

To provide an interface for browsing such meetings, related art implementations have provided a search mechanism, wherein if the meeting is properly indexed using speech to text and optical character recognition (OCR), a search interface can return snippets (e.g., key frames) extracted from videos, allowing users to quickly extract relevant parts of a video meeting.

In such related art search systems, the source streams can be subdivided using both a speaker segmentation and topic information derived from the speech transcripts in a multi-level video segmentation.

### SUMMARY

Aspects of the present disclosure may include a method for representing meeting content. The method may involve processing an online presentation for one or more media segments; extracting information from the one or more media segments indicative of one or more relationships between one or more participants of the online presentation and; generating an interface for the online presentation, the interface indicative of the one or more relationships between the one or more participants of the online presentation.

Aspects of the present disclosure may further include a non-transitory computer readable medium, storing instructions for a process for representing meeting content. The instructions may further include processing an online presentation for one or more media segments; extracting information from the one or more media segments indicative of one or more relationships between one or more participants of the online presentation and; generating an interface for the online presentation, the interface indicative of the one or more relationships between the one or more participants of the online presentation.

Aspects of the present disclosure may further include an apparatus, which may involve a processor, configured to process an online presentation for one or more media segments; extract information from the one or more media segments indicative of one or more relationships between one or more participants of the online presentation and; generate an interface for the online presentation, the interface indicative of the one or more relationships between the one or more participants of the online presentation.

### BRIEF DESCRIPTION OF DRAWINGS

FIGS. 1(a) to 1(c) illustrate several states in a generated video of a meeting recording or several panels of the storyboard, in accordance with an example implementation.

FIG. 2 illustrates an example of a transition between speakers, in accordance with an example implementation.

FIG. 3 illustrates an example of title keyframes, in accordance with an example implementation.

FIG. 4 illustrates an example implementation involving the application of affect.

FIG. 5 illustrates an example flow diagram in accordance with an example implementation.

FIG. 6 illustrates a flow diagram in accordance with an example implementation.

FIG. 7 illustrates an example computing environment with an example computer device suitable for use in example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

In example implementations as described herein, the interface is described in the form of a summary of a particular presentation, however, other implementations are also possible and the present disclosure is not limited thereto. For example, the interface may be in the form of a general template interface that is modified to navigate a particular presentation. Online presentations can refer to presentations given online involving documents and/or can also include recorded meetings between two or more participants in either a live situation (e.g. conference room), or meetings over the internet through a messenger application, or phone conferences that are recorded and made accessible online.

A search-based interface is limited in that a user must know what they are searching for, in advance of performing the search. Additionally, the simple result snippets of the related art implementations are of limited use in helping users understand the overall context of the meeting. Related art implementations have addressed this problem by providing improved snippets that overlay actions people performed over shared documents during meetings. However, such overlays do not represent the meeting as a whole, and do not provide context across the meeting.

Further, the related art only discloses archival systems for online presentations with primitive systems for providing search results. Such archival systems only perform minimal analysis on the online presentation to index the online presentation. The example implementations of the present disclosure address the fundamental problem of lack of searchability of an individual online presentation by a combination of processes that generates an interface directed to an individual online presentation.

By using recorded metadata (such as who speaks when, their webcam image, their screen captures, chat messages, mouse actions, etc.), the example implementations of the present disclosure generate a rapidly skimmable version of the meeting with two representations: one that users can manipulate like a video with a timeline, and another that appears as a storyboard interface.

With the interface according to the example implementations, a user can very quickly get the gist of the meeting, such as speaker turns (e.g., who spoke when), identify times when important (e.g., highly relevant) back and forth discussions are happening versus those when mostly one person talked, identify topics that were discussed (e.g., using speech to text, OCR from screen sharing and chat messages), confirm (e.g., see) what was shared (e.g., screenshots or shares, whiteboard images, chats, links), and confirm (e.g., see) what was done while sharing such as mouse motions over documents. Once a point of interest is found, users can replay the meeting at that time.

Furthermore, users can search and filter the generated view of the meeting by using keywords and metadata (e.g. show only when John was speaking, when a chat was sent, slide was shown).

Example implementations of the present disclosure generate two new representations of the meeting, which can be in the form of a video-like skimming presentation or a storyboard, but is not limited thereto. Each panel in the storyboard and each segment of the skimming presentation utilize an implementation wherein the face of each participant is shown over an area (e.g., rectangular, circular, and so on) that represents the main shared content. In an example, the faces of the participants show the captured key frames of each participant, and a halo around them can denote that they were talking. The size of the halo may indicate relative talk time. The example implementations utilize a halo, but other implementations are also possible (e.g., grayscale to color tone, size, etc.) depending on the desired implementation, and the present disclosure is not limited to a halo implementation. In another example implementation, the faces of the participants can be connected by arrows or other indicia of different thicknesses to indicate speaker transitions during the segment being represented by a storyboard panel or the current part of the skimming presentation.

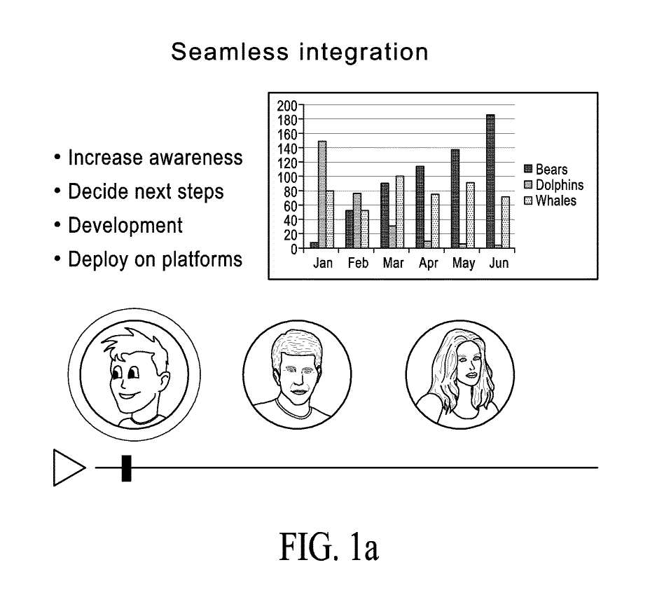

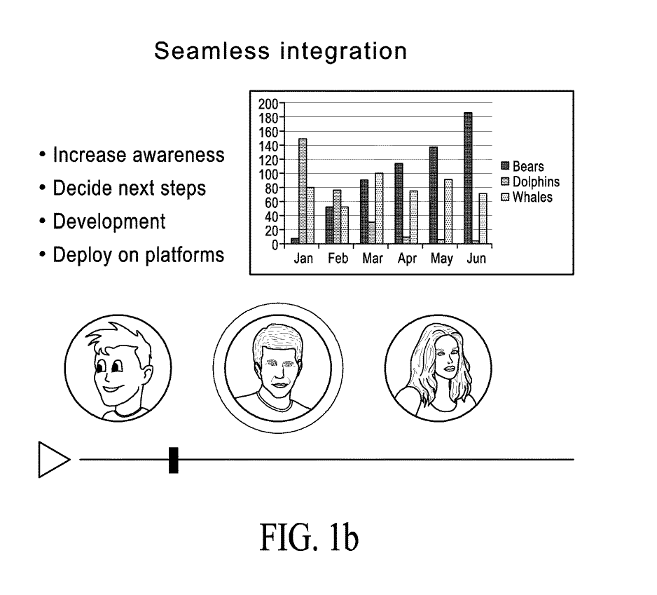

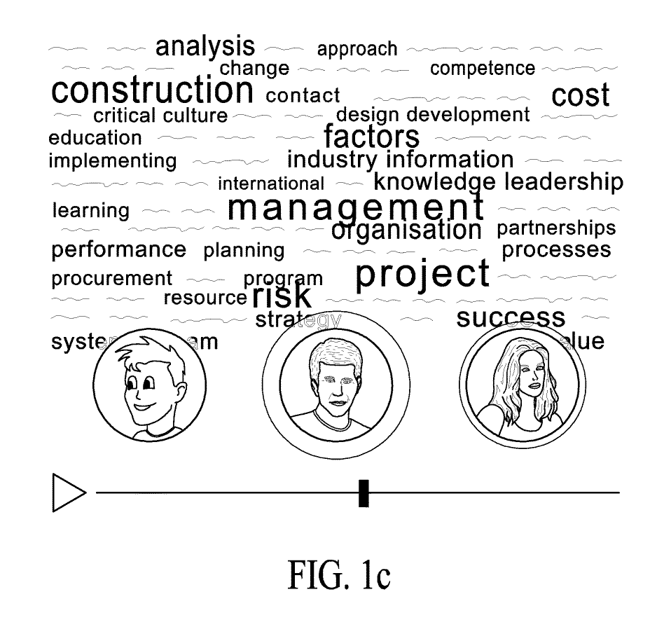

FIGS. 1(a) to 1(c) illustrate several states in a generated video of a meeting recording or several panels of the storyboard, in accordance with an example implementation. As illustrated in the example implementations of FIGS. 1(a) to 1(c), there are different title keyframes for each segment, with a halo depicting the speaker that is talking. In the example of FIG. 1(a), the first user talks, and others listen, while the user shows a slide. In FIG. 1(b), the second user talks over the shared slide and points to the chart with his mouse. As illustrated in FIGS. 1(a) and 1(b), the primary area illustrates shared content such as a document, picture, screen, chat message, whiteboard picture and other presentation materials.

In the example of FIG. 1(c), there is an important interaction between two users, with size of the halo indicating relative talk time. Important keywords extracted by speech-to-text indicate that the two users talked about project management. As illustrated in FIG. 1(c), when no content is being shared, the background area instead shows keywords judiciously extracted from the text to speech channel. Depending on the desired implementation, other strings including words, such as generated tags from metadata, may also be utilized, and the present disclosure is not limited thereto from text to speech implementations.

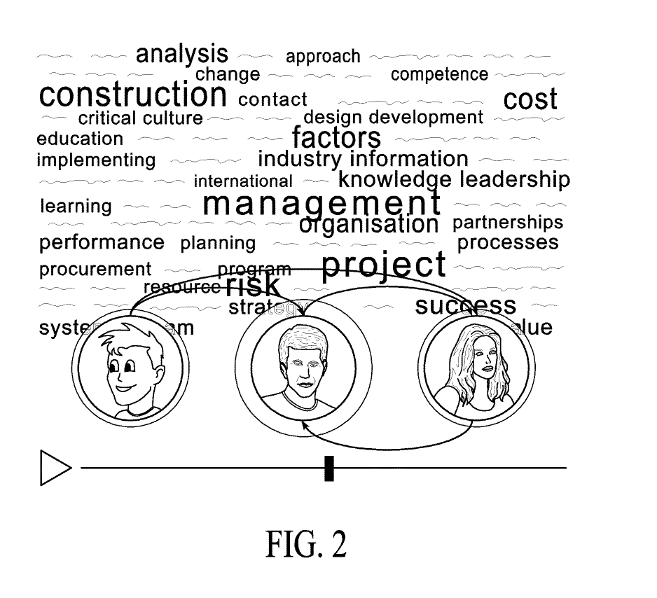

FIG. 2 illustrates an example of a transition between speakers, in accordance with an example implementation. Specifically, the example of FIG. 2 represents the keyframe from FIG. 1(c) which utilizes transitions between speakers where the thickness of arrows represents transition count and duration. Transitions between speakers also provide valuable information about a segment of a meeting, such as the interactions between speakers, which speakers participated in a particular segment, and so on. The example of FIG. 2 shows how such transitions can be visualized with arrows. The thickness of an arrow can represent the count of transitions, the total length of time the speaker after the transition spoke, or a weighted average of the two.

Alternative visualizations for speaker durations may use different image sizes to indicate the amount of time each meeting attendee spoke. Such images of different sizes may be arranged in form of a comic book page, or other method depending on the desired implementation. In another example implementation, speech bubbles in such a comic book page can show the most important aspects or summaries of the speech, wherein importance can be defined based on the desired implementation. To present the text in a meeting segment, one can use a word cloud as depicted in FIG. 2. Such an approach is fairly robust with respect to errors in speech recognition, because misrecognized words tend to have a low frequency and thus would not be noticeable in the word cloud. One can also set a threshold for word frequency, eliminating words below the threshold, in accordance with the desired implementation.

Meetings often have multiple topics. In example implementations, presenting a separate summary for each topic makes it easier to skim the meeting. Example implementations may also utilize self-similarity of text that can detect topic boundaries. For meetings, building a topic segmentation that clusters adjacent speaker segments using inter-segment text similarity may be a natural choice. Voice activity detection is built into the meeting of clients, and can be used to derive speaker boundaries. Pairwise segment similarity can be quantified by extracting various text features representing the spoken text in each segment.

Once higher level topic boundaries have been determined, each topic can be visualized separately, or associated with representative text mined from automatic speech recognition (ASR) transcripts or screen text depending on the desired implementation. Keyphrase detection in meetings and lectures is well studied in natural language processing (NLP) using manual transcripts. Other text mining approaches can be more appropriate for working with ASR transcripts.

Example implementations may also be configured to use several data channels to create the visualization. If available, peers can be represented by their webcam stream, or their avatar/name. For ease of video skimming, the example implementations may also adjust the location of (e.g., center) the face of the participants.

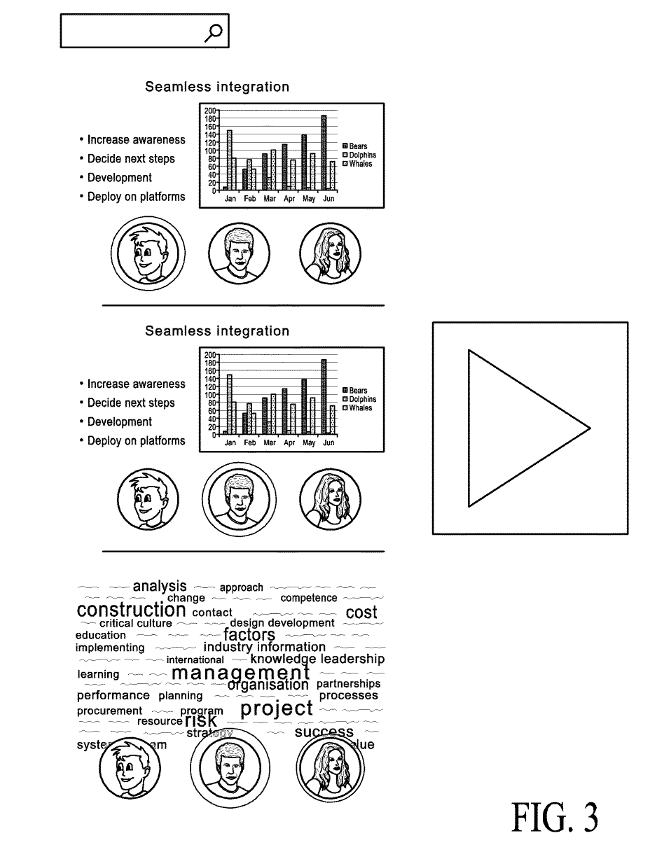

FIG. 3 illustrates an example of title keyframes, in accordance with an example implementation. In the example interface of FIG. 3, title keyframes can also be presented in a storyboard format. In the example implementation of FIG. 3, clicking on a keyframe can navigate to its segment in the video or chat log. Users of the interface can manually filter keyframes using a search box.

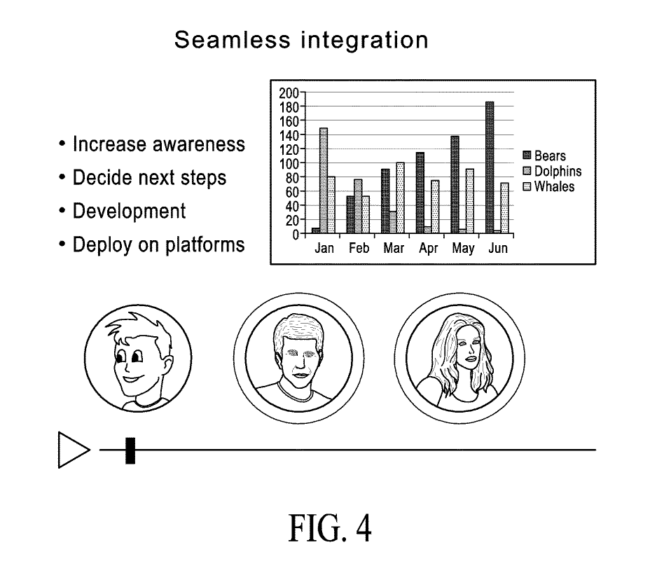

Example implementations may also apply affect. Affect (e.g., extracted from voice, text messages, sensors, etc.), can be applied by example implementations to color keywords and halos around the face of a participant. FIG. 4 illustrates an example implementation involving the application of affect. In an example as illustrated in FIG. 4, emotion color wheels can be used as a general framework to pick the colors. FIG. 4 illustrates an example where a halo or a glow around the faces of the participants can indicate affect. The glow in FIG. 4 indicates surprise from the participants, which can help a user skimming the meeting quickly find important segments. In the example of FIG. 4, two users reacted with surprise to a statement likely given earlier by the first user. By way of example, a green halo can indicate a happy participant, yellow halo can indicate a surprised participant, red can indicate an angry participant, blue can indicate a sad participant, and violet can indicate a disgusted participant. The example color selection can be altered according to a desired implementation (e.g., greyscale, temperature map, etc.) and is not confined to the above example affect color settings. Further, other indications can be used (e.g., shape, size, etc.) depending on the desired implementation, and also a halo can be substituted for other indications (e.g., highlight, audio cue, graphical icon indicators, etc.), depending on the desired implementation.

In example implementations the level of activity around people can be represented by a halo around the participant. The voice detector can be utilized to compute the level of activity, but other signals can also be utilized in accordance with the desired implementation, such as the amount of mouse/text actions and chat messages sent at the time. Those example signals can also aid in the visualization in order to help a user better skim a meeting.

The background frame adjacent to decorated people's faces are made of important material being shared at that time, e.g. a webcam stream showing a whiteboard in the room, a picture taken of a document, a screen being shared, a document being uploaded.

Example implementations can also automatically determine the materials to present. In the case of a multi-participant meeting, there may be many potential items of interest being shared among the various attendees. In an example implementation, multiple parties may be sharing documents or images, while others may be streaming a video feed of their face. In such a case, the example implementations may be able to infer which of these materials are of interest to preserve and present in the summary based on how many participants have maximized the presentation in their individual view.

Example implementations may also be applied to chat based applications. Besides web-based meetings, example implementations may be utilized to skim chat sessions that can be found, for example, in enterprise applications. Even without webcam feeds, these sessions also contain participants, their level of engagement during the “meeting”, files that have been shared (documents, images, links to videos, etc.) and of course all the text messages that can readily be mined for affect (e.g. using emoticons or sentiment analysis) and keyword extraction. As such, the same technique described to visualize video web meetings is also applicable to visualize chat sessions.

Example implementations may also provide for the customization of the presentation with search. Instead of viewing a summary of the entire meeting, users may indicate what they are interested in through a search interface as illustrated in the example of FIG. 3. One part of the search interface offers full-text search of recognized speech and shared documents. In an example implementation, parts of the meeting matching the search are summarized. Matching words can be highlighted in the shared documents and in the keywords extracted by speech-to-text. In addition, speakers may be specified, either by clicking on their images or by including them in the search text (e.g., “@Able”). Finally, shared documents may be selected from a list of thumbnails representing all documents shared during the meeting. Parts of the meetings while the selected documents were shared are summarized.

Using the search interface of the example implementations, a user can also see a version of the meeting that emphasizes the activities of a participant. This can be used for example to see the participant's own version of the meeting (e.g., “what actions I have had”), as well as seeing the actions of other participants and potentially mixing a few people, (e.g. “show me the skimmable meeting summary of @Mary and @John”).

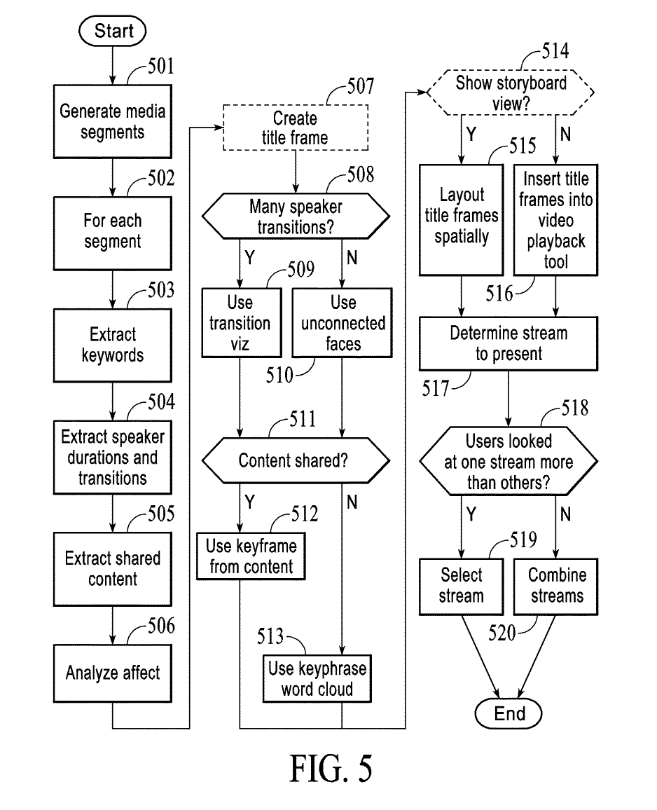

FIG. 5 illustrates an example flow diagram in accordance with an example implementation. At 501, the example implementations may obtain media segments, which can be in the form of video, audio, presentations, keywords, chats and any other media that may occur in a web meeting or conference. At 502, the process for processing each segment is initiated. At 503, keywords can be extracted from chats, from text to speech, from OCR or from other materials provided from the media segments according to the desired implementation. At 504, speaker durations and transitions are determined from the media segments.

Speaker changes and durations can be detected by any desired implementations known in the art. Information that can be captured at this flow can include how long a speaker is presenting until the next person speaks, including the number of times a speaker has presented, the number of times a particular speaker has presented after a given speaker, and so on, according to the desired implementation.

At 505, information regarding shared content is also determined from the media segments. Shared content can be identified by any method depending on the desired implementation and weighed based on the interaction conducted with the shared content. In an example, but not by way of limitation, a scoring can be applied to the shared content based on the number of participants interacting with the shared content, importance associated with the presenter, number of times shared, and so on depending on the desired implementation.

At 506, affect can be determined from the media material. Affect to determine user input such as surprise, anger, and whatever information is desired according to the desired implementation as descried in the example implementation of FIG. 4.

At 507, the process to generate a title frame is initiated wherein the title frame is determined based on the information extracted from the media segments. At 508, for the construction of a title frame, a determination is made as to if there are many speaker transitions. The determination can be made, for example, by an application of a threshold, by a preset definition, or by any other methods according to the desired implementation. If so (Y), then a transition visualization can be created as the title frame as indicated at 509, otherwise (N), unconnected faces can be applied at 510. In such an implementation, if there are a number of transitions between speakers that fall below the determination, then graphics can be added to indicate the transitions between speakers (e.g., through arrows as illustrated in FIG. 4, through an interface indicating the transitions, etc.). If the transitions exceed the determination, then alternative methods such as transition diagram or other diagrams may be utilized depending on the desired implementation.

At 511, a determination is made if content is shared or not. If content is shared (Y), then the keyframe from the content is used at 512. If not (N), then a keyphrase word cloud may be used at 513.

At 514, a determination is performed as to if the storyboard view is to be shown. If so (Y), then the flow proceeds to 515 to layout the title keyframes spatially. Otherwise (N), the flow proceeds to 516 wherein title keyframes are inserted into the video playback tool.

At 517, the process for determination of a stream to present is initiated. At 518, a determination is made as to whether the users looked at one stream more than others. If so (Y) then the flow proceeds to 519 to select the stream that has been viewed (e.g., accessed) more than other streams. If not (N), then the flow proceeds to 520, wherein the streams can be combined.

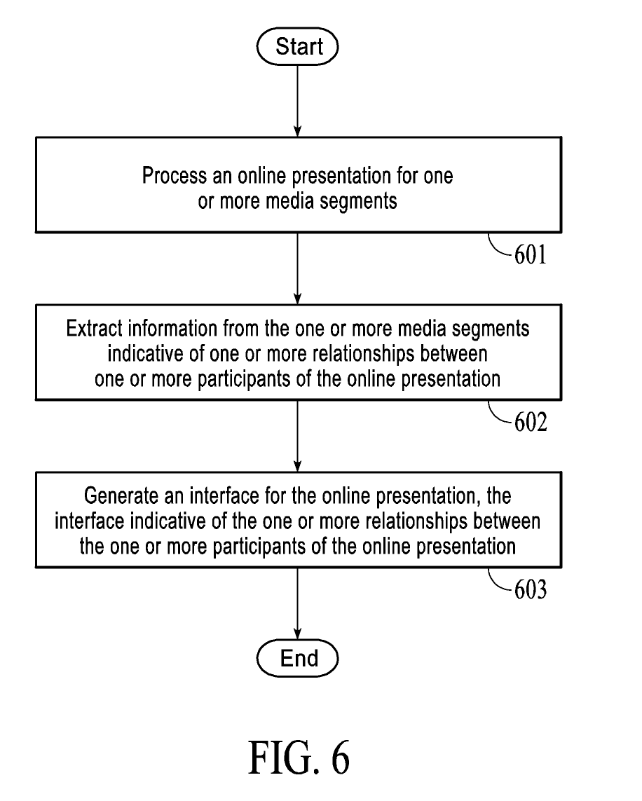

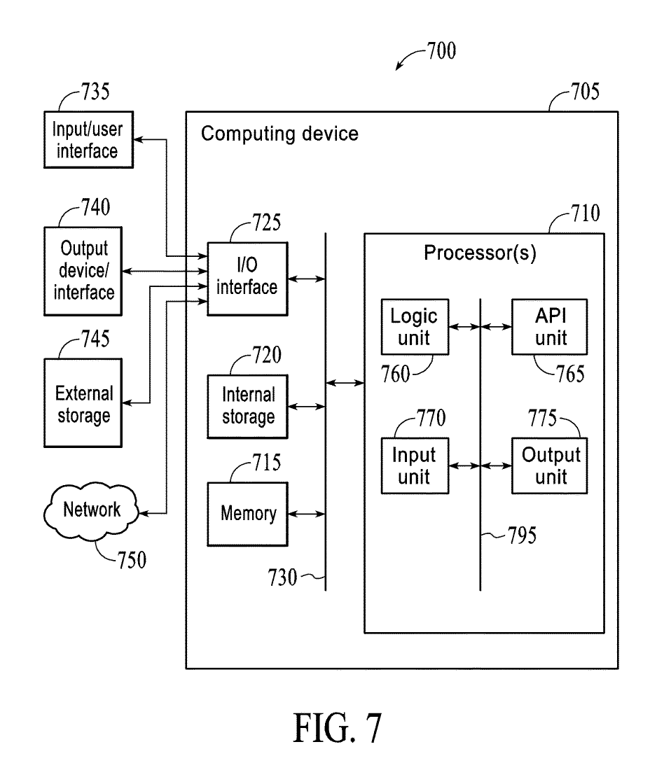

FIG. 6 illustrates a flow diagram in accordance with an example implementation. At 601, the system is configured to process an online presentation for one or more media segments. At 602, the system is configured to extract information from the one or more media segments indicative of one or more relationships between one or more participants of the online presentation. At 603, the system is configured to generate an interface for the online presentation, the interface indicative of the one or more relationships between the one or more participants of the online presentation. The flow diagram of FIG. 6 can be implemented in an apparatus as described with respect to FIG. 7.

FIG. 7 illustrates an example computing environment with an example computer device suitable for use in example implementations. For example, the example computer devices outlined below can be utilized with a presentation archive system to enhance the presentation archive system with an online presentation interface generation system that provides an indexing for an online presentation. Computer device 705 in computing environment 700 can include one or more processing units, cores, or processors 710, memory 715 (e.g., RAM, ROM, and/or the like), internal storage 720 (e.g., magnetic, optical, solid state storage, and/or organic), and/or I/O interface 725, any of which can be coupled on a communication mechanism or bus 730 for communicating information or embedded in the computer device 705.

Computer device 705 can be communicatively coupled to input/user interface 735 and output device/interface 740. Either one or both of input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computer device 705. In other example implementations, other computer devices may function as or provide the functions of input/user interface 735 and output device/interface 740 for a computer device 705.

Examples of computer device 705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 705 can be communicatively coupled (e.g., via I/O interface 725) to external storage 745 and network 750 for communicating with any number of networked components, devices, and systems, including one or more computer devices of the same or different configuration. Computer device 705 or any connected computer device can be functioning as, providing services of, or referred to as a server, client, thin server, general machine, special-purpose machine, or another label.

I/O interface 725 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computer device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Memory 715 may be configured to store or manage a database of online presentations. In such an example implementation, Memory 715 may be configured to function as an archive for online presentations that are generated by any methods according to the desired implementation. The online presentations can be processed by processor(s) 710 according to example implementations as described below. The example implementations as described herein may be conducted singularly, or in any combination of each other according to the desired implementation and are not limited to a particular example implementation.

Processor(s) 710 can execute under any operating system (OS) (not shown), in a native or virtual environment. One or more applications can be deployed that include logic unit 760, application programming interface (API) unit 765, input unit 770, output unit 775, and inter-unit communication mechanism 795 for the different units to communicate with each other, with the OS, and with other applications (not shown). The described units and elements can be varied in design, function, configuration, or implementation and are not limited to the descriptions provided.

In some example implementations, when information or an execution instruction is received by API unit 765, it may be communicated to one or more other units (e.g., logic unit 760, input unit 770, output unit 775). In some instances, logic unit 760 may be configured to control the information flow among the units and direct the services provided by API unit 765, input unit 770, output unit 775, in some example implementations described above. For example, the flow of one or more processes or implementations may be controlled by logic unit 760 alone or in conjunction with API unit 765. The input unit 770 may be configured to obtain input for the calculations described in the example implementations, and the output unit 775 may be configured to provide output based on the calculations described in example implementations.

Processor(s) 710 can be configured to process an online presentation for one or more media segments, extract information from the one or more media segments indicative of one or more relationships between one or more participants of the online presentation and generate an interface for the online presentation, the interface indicative of the one or more relationships between the one or more participants of the online presentation as illustrated in FIG. 6 by utilizing implementations as described in FIG. 5.

In an example implementation, processor(s) 710 can be configured to generate an interface for the online presentation, the interface indicative of the one or more relationships between the one or more participants of the online presentation. The interface generated can be a video-like or storyboard interface configured to allow users to quickly skim an abstracted representation of the meeting or chat content as illustrated in FIGS. 1(a) to 1(c), and 2-4.

In an example implementation, processor(s) 710 can be configured to extract information from the one or more media segments indicative of one or more relationships between one or more participants of the online presentation. In an example implementation the one or more relationships between the one or more participants of the online presentation can include a level of engagement of the one or more participants. Based on the level of engagement extracted from the information, processor(s) 710 can be configured to generate the interface for the online presentation by generating an avatar for each of the one or more participants, with the avatar including a halo indicative the level of engagement. Through such an implementation, the participation level of the participants is shown with understandable halos around their webcam stream or avatar where the halo intensity maps to the level of engagement of that user at that time. Such halos can be implemented as illustrated, for example, in FIGS. 1(a) to 1(c), and 2-4.

In another example implementation, processor(s) 710 can be configured to extract information from the one or more media segments indicative of one or more relationships between one or more participants of the online presentation with the one or more relationships between the one or more participants involving turns taken between participants during the online presentation. Processor(s) 710 are configured to generate the interface for the online presentation by generating indications between one or more avatars representing the one or more participants, the indications indicative of turns taken between the one or more participants. In such an example implementation, the generated interface can be a storyboard version which uses indicators such as arrows, lines or other indicia to indicate turn-taking between participants as illustrated in FIG. 2.

In an example implementation, processor(s) 710 can be configured to extract, from the media segments, media elements shared during the online presentation. Such shared media elements can include presentation slides, shared screens, chat text, video streams, and any other shared material during the online presentation depending on the desired implementation. Processor(s) 710 can be configured to generate the interface for the online presentation by generating at least one of shared media between the one or more participants and keywords extracted from audio recognition of the media segments as illustrated in FIGS. 1(a) to 1(c) and 2-4. In this manner, the apparatus can be configured to generate an interface wherein the background is used to display important elements being shared at the time (chat messages, documents, screen-shares, keywords extracted from text-to-speech).

In example implementations, processor(s) 710 are configured to determine the importance of each online presentation stream of the one or more participants as described, for example, in FIG. 5. In an example, but not by way of limitation, a scoring can be applied to each of the online presentation streams based on the number of participants interacting with the online presentation stream, importance associated with the presenter, number of times shared, and so on depending on the desired implementation. Each participant in the online presentation may have their own presentation stream that is streamed during the online presentation, which can include video feed from the webcam of the participant, chat text, audio input, screen shares, and so on depending on the desired implementation. Systems generating the online presentation may record all streams which can be analyzed by processor(s) 710. Processor(s) 710 can be configured to generate the interface for the online presentation by selecting the stream for each presentation time of the online presentation based on the importance, as scored in the example implementations described above. In such example implementations, the background of the generated interface can be automatically chosen based on interred importance among the several candidate streams of each participant based on what the participants are focused on, mouse cursor motion over a particular stream, engagement in the chat window, and so on according to the desired implementation.

In example implementations, processor(s) 710 are configured to detect affect from the media segments, and wherein the generating the interface for the online presentation comprises overlaying an indication indicative of an affect on an avatar for each of the one or more participants as described in FIG. 4. As illustrated in the example implementation of FIG. 4, the halo and text colors can be mapped to affect detected from the faces of the participants (e.g. smiling), text content (e.g. emoticons in chat window) and voice signal (e.g., loud, quiet, fast paced, inquisitive, agreeing).

In an example implementation, processor(s) 710 may be configured to generate the interface for the online presentation by generating a search interface based on keywords generated from the media segments. In such an implementation, the interface (e.g., video-like or storyboard) can be queried with text keywords or the names of the participants in order to create filtered version, thereby allowing users to generate personalized views onto the meeting or chat recordings.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for representing meeting content, the method comprising:
processing an online presentation for one or more media segments;
extracting information from the one or more media segments indicative of one or more relationships between one or more participants of the online presentation and;
generating a summary for the online presentation, the summary indicative of the one or more relationships between the one or more participants of the online presentation.

2. The method of claim 1, wherein the one or more relationships between the one or more participants of the online presentation comprises a level of engagement of the one or more participants, wherein the generating the summary for the online presentation comprises generating an avatar for each of the one or more participants, the avatar comprising a halo indicative the level of engagement.

3. The method of claim 1, wherein the one or more relationships between the one or more participants comprises turns taken between participants during the online presentation, wherein the generating the summary for the online presentation comprises generating indications between one or more avatars representing the one or more participants, the indications indicative of the turns taken between the one or more participants.

4. The method of claim 1, further comprising extracting, from the media segments, media elements shared during the online presentation, wherein the generating the summary for the online presentation further comprises generating at least one of the media elements shared between the one or more participants and keywords extracted from audio recognition of the media segments.

5. The method of claim 1, further comprising determining an importance of each online presentation stream of the one or more participants, wherein the generating the summary for the online presentation comprises selecting the stream for each presentation time of the online presentation based on the importance.

6. The method of claim 5, further comprising using the selected stream as a background for the summary.

7. The method of claim 1, further comprising detecting affect from the media segments, and wherein the generating the summary for the online presentation comprises overlaying an indication indicative of an affect on an avatar for each of the one or more participants.

8. The method of claim 1, wherein the generating the summary for the online presentation comprises generating a search interface based on one or more keywords generated from the media segments.

9. The method of claim 1, wherein the summary comprises an interface configured to skim media segments.

10. The method of claim 1, wherein the summary comprises a storyboard, the storyboard comprising of images from the media segments, presentation material, and information about the participants.

11. A non-transitory computer readable medium, storing instructions for a process for representing meeting content, the instructions comprising:
processing an online presentation for one or more media segments;
extracting information from the one or more media segments indicative of one or more relationships between one or more participants of the online presentation and;
generating a summary for the online presentation, the summary indicative of the one or more relationships between the one or more participants of the online presentation.

12. The non-transitory computer readable medium of claim 11, wherein the one or more relationships between the one or more participants of the online presentation comprises a level of engagement of the one or more participants, wherein the generating the summary for the online presentation comprises generating an avatar for each of the one or more participants, the avatar comprising a halo indicative the level of engagement.

13. The non-transitory computer readable medium of claim 11, wherein the one or more relationships between the one or more participants comprises turns taken between participants during the online presentation, wherein the generating the summary for the online presentation comprises generating indications between one or more avatars representing the one or more participants, the indications indicative of the turns taken between the one or more participants.

14. The non-transitory computer readable medium of claim 11, the instructions further comprising extracting, from the media segments, media elements shared during the online presentation, wherein the generating the summary for the online presentation further comprises generating at least one of the media elements shared between the one or more participants and keywords extracted from audio recognition of the media segments.

15. An apparatus, comprising:
a processor, configured to:
process an online presentation for one or more media segments;
extract information from the one or more media segments indicative of one or more relationships between one or more participants of the online presentation and;
generate a summary for the online presentation, the summary indicative of the one or more relationships between the one or more participants of the online presentation.

16. The apparatus of claim 15, wherein the one or more relationships between the one or more participants of the online presentation comprises a level of engagement of the one or more participants, wherein the processor is configured to generate the summary for the online presentation by generating an avatar for each of the one or more participants, the avatar comprising a halo indicative the level of engagement, wherein the level of engagement determined based on at least one of voice and user input received from the one or more participants,
wherein a background frame of the summary is selected based on material from the one or more media segments presented at a time.

17. The apparatus of claim 15, wherein the one or more relationships between the one or more participants comprises turns taken between participants during the online presentation, wherein the processor is configured to generate the summary for the online presentation by generating indications between one or more avatars representing the one or more participants, the indications indicative of turns taken between the one or more participants.

18. The apparatus of claim 15, wherein the processor is further configured to extract, from the media segments, media elements shared during the online presentation, wherein the processor is configured to generate the summary for the online presentation by generating at least one of the media elements shared between the one or more participants and keywords extracted from audio recognition of the media segments;
wherein the processor is configured to generate a search interface for the summary based on at least one of the keywords extracted from audio recognition of the media segments, keywords extracted from text chat portions of the media segments.

19. The apparatus of claim 15, wherein the processor is further configured to determine an importance of each online presentation stream of the one or more participants, wherein the processor is configured to generate the summary for the online presentation by selecting the stream for each presentation time of the online presentation based on the importance; wherein the importance is determined from interest from the one or more participants based on a count of maximized views of the each online presentation stream.

20. The apparatus of claim 15, wherein the processor is further configured to detect affect from the media segments, and wherein the processor is configured to generate the summary for the online presentation by overlaying an indication indicative of an affect on an avatar for each of the one or more participants.
